(19) United States
(12) Patent Application Publication
(10) Pub. No.: US 2007/0229308 A1
(43) Pub. Date: Oct. 4, 2007

(54) PEDESTRIAN ALERT APPARATUS AND METHOD

(76) Inventors: STEVEN ROBERT STALP, TUCSON, AZ (US); BERNARD JOSEPH STALP, SILVERLAKE, WA (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/687,577

(22) Filed: Mar. 16, 2007

Related U.S. Application Data
(60) Provisional application No. 60/783,013, filed on Mar. 16, 2006.

(51) Int. Cl. G08G 1/095

(52) U.S. Cl. 340/944

(57) ABSTRACT

An apparatus and method are disclosed to monitor movement in intersecting pathways. The apparatus comprises a pedestrian alert device comprising a housing comprising a first surface facing a first direction and a second surface facing a second direction, wherein said first direction differs from said second direction. The pedestrian alert device further comprises a controller disposed within the housing, a first sensor disposed on the first surface and interconnected with the controller, a second sensor disposed on the second surface and interconnected with the controller, and at least one light emitting device disposed on the housing and interconnected with the controller.

### CROSS-REFERENCE TO RELATED APPLICATIONS

This Application claims priority from a United States Provisional Application filed Mar. 16, 2006, and having Ser. No. 60/783,013.

### BACKGROUND OF THE INVENTION

In a busy work environment, collisions can occur between persons walking down intersecting hallways, or among office cubicles, between rows of shelving in a warehouse or store, or down a corridor with objects blocking the view. Such collisions are likely to happen when one or both people are using a cellular phone, carrying one or more objects, or are otherwise not paying attention to their direction of travel.

### SUMMARY OF THE INVENTION

Applicants' invention comprises an apparatus and method to monitor movement in intersecting pathways. In certain embodiments, such intersecting pathways may comprise intersecting hallways. In certain embodiments, a first pathway comprises one side of a door, and the second pathway comprises the opposite side of that door. In certain embodiments, Applicants' apparatus and method can be used at the intersection of more than two pathways.

Applicants' apparatus comprises a pedestrian alert device comprising a housing comprising a first surface facing a first direction and a second surface facing a second direction, wherein the first direction differs from the second direction. In certain embodiments, the housing comprises a door or portion thereof, office cubicle, wall, stairway, and the like.

Applicants' pedestrian alert device further comprises a controller disposed within the housing, a first sensor disposed on the first surface and interconnected with the controller, a second sensor disposed on the second surface and interconnected with the controller, and at least one light emitting device disposed on the housing and interconnected with the controller.

Applicants' method supplies Applicants' pedestrian alert device, and disposes that pedestrian alert device at the intersection of a first pathway and a second pathway. If Applicants' pedestrian alert device detects movement in either or both pathways, then the method activates the one or more light emitting devices.

Applicants' pedestrian alert device can be used inside a building, structure, or dwelling, or outside a building, structure, or dwelling. Applicants' pedestrian alert device can be added to one or more exterior portions, one or more or interior portions of a building, structure, or dwelling. Applicants' pedestrian alert device can be incorporated into cubicles, doors, or other potential sight-limiting structures at the time of manufacture.

### BRIEF DESCRIPTION OF THE DRAWINGS

The invention will be better understood from a reading of the following detailed description taken in conjunction with the drawings in which like reference designators are used to designate like elements, and in which:

FIG. 1A is a block diagram showing the exterior of one embodiment of Applicants' pedestrian alert apparatus;

FIG. 1B is a block diagram showing the components of one embodiment of Applicants' pedestrian alert apparatus;

FIG. 2 is a top view illustrating intersecting hallways and Applicants' pedestrian alert apparatus disposed at the intersection;

FIG. 3 is a side view of a wheeled vehicle comprising a receiver element of Applicants' pedestrian alert apparatus;

FIG. 4 is a block diagram of a wireless receiver element of Applicants' pedestrian alert apparatus;

FIG. 5 is a block diagram showing one embodiment of the power source for Applicants' pedestrian alert apparatus;

FIG. 6 is a perspective view showing Applicants' pedestrian alert apparatus comprising two separate detection zones for a single sensor device;

FIG. 7 is a flow chart summarizing the steps of Applicants' method using Applicants' pedestrian alert apparatus; and

FIG. 8 is a perspective view illustrating an embodiment of Applicants' apparatus wherein each sensor comprises two sensing elements.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

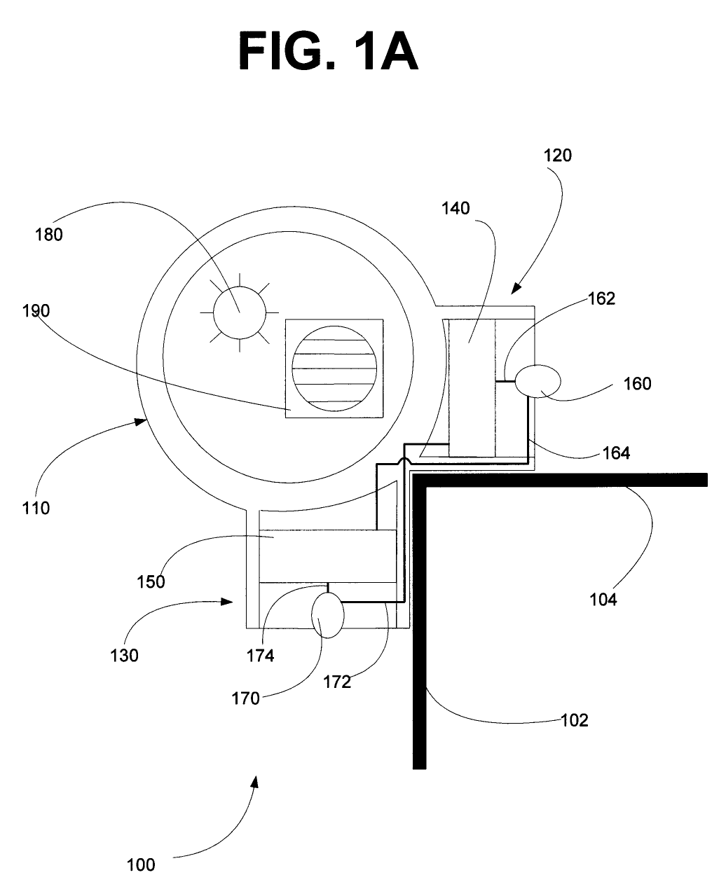

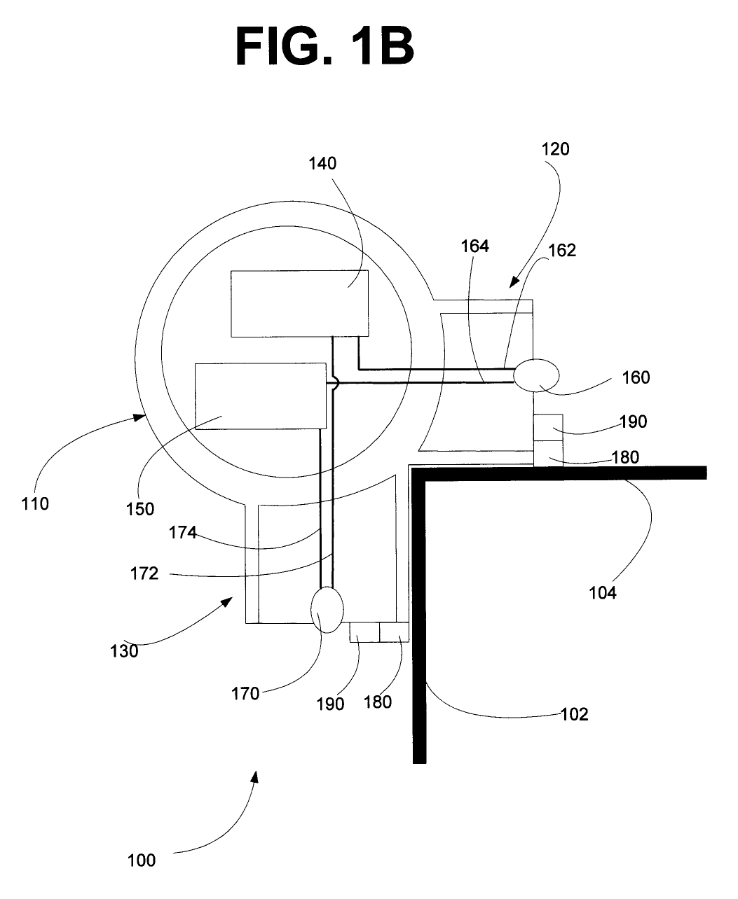

Referring now to FIG. 1A, Applicants' apparatus 100 comprises a housing 110, housing 120 attached to and extending outwardly in a first direction from housing 110, and housing 130 attached to and extending outwardly in a second direction from housing 110. In the illustrated embodiment of FIG. 1, the first direction is perpendicular to the second direction. In certain embodiments, one or more pedestrian sensors and/or one or more light-emitting devices are disposed behind a lens, such as a Fresnel lens, and are aligned at a predefined angle. Apparatus 100, 120, and 130 may be connected or may be separately located.

In certain embodiments, one or more light emitting devices 180 are disposed within housing 110 and extend outwardly therefrom. In certain embodiments, one or more light emitting device 180 are disposed on the outer surface of housing 110. By “light emitting device,” applicant means a device which emits electromagnetic radiation in the visible spectrum. As those skilled in the art will appreciate, such a light emitting device may comprise an incandescent bulb, a fluorescent bulb, a light emitting diode, laser, strobe light, and the like.

In certain embodiments, one or more sound emitting devices, i.e. audio devices, 190 are disposed within housing 110 and extend outwardly therefrom. In certain embodiments, one or more sound emitting devices 190 are disposed on the outer surface of housing 110.

Apparatus 100 comprises a power source 140, a controller 150, a first sensor 160 disposed in housing 120, and a second sensor 170 disposed in housing 130. In certain embodiments, sensor 160 and/or sensor 170 are disposed within a housing formed to include a slot or aperture, such that visible light, or infrared light, or acoustic waves, can pass into the housing through the slot/aperture. In other embodiments, sensors 160 and 170 are mounted in housing 110. Sensor 160 is interconnected with power source 140 via power conduit 162. Sensor 160 is interconnected with controller 150 via communication link 164. Sensor 170 is interconnected with power source 140 via power conduit 172. Sensor 170 is interconnected with controller 150 via communication link 174. In the illustrated embodiment of FIG. 1A, apparatus 100 comprises two sensors. In other embodiments, apparatus 100 comprises a plurality of sensors interconnected with one or more controllers.

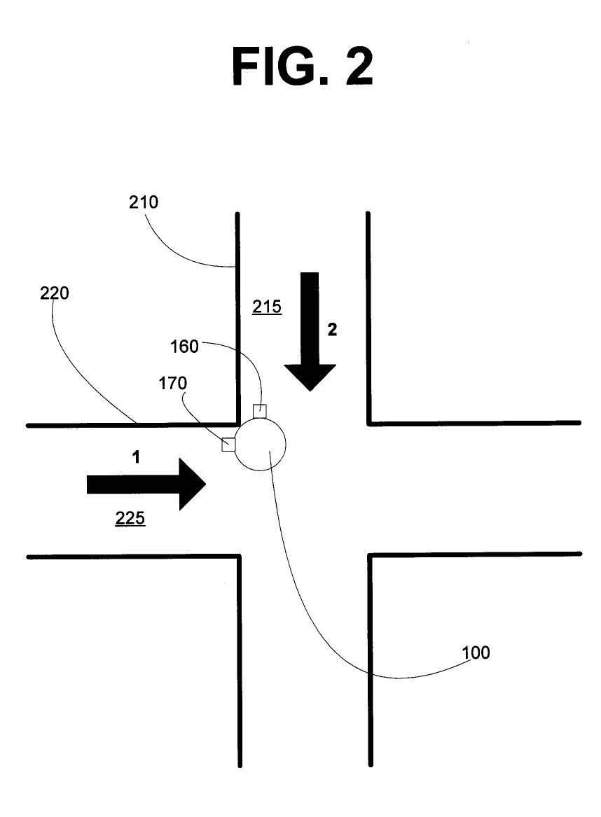

In the illustrated embodiment of FIG. 1A, apparatus 100 is attached to supports 102 and 104, wherein those supports are perpendicular to one another. In certain embodiments, supports 102 and 104 comprise walls that define intersecting pathways. For example and referring to FIG. 2, apparatus 100 is disposed on walls 210 and 220 at the intersection of pathways 215 and 225. In certain embodiments, walls 210 and 220 comprise office partitions used to define individual office spaces. In certain embodiments, walls 210 and 220 comprise rows of shelving disposed in a warehouse facility or sales establishment.

As described hereinbelow, the one or more light emitting devices 180, and the one or more sound emitting devices 190 are interconnected with controller 150 such that if sensor 160 and/or sensor 170 detect motion in a monitored pathway, controller 150 causes apparatus 100 to display a visual alert and/or emit an audible or other alert.

In certain embodiments, sensor 160 and/or 170 comprises an ultrasonic transducer which emits acoustic sound waves in combination with one or more ultrasound detectors which can detect reflected acoustic waves. Movement of persons, animals, vehicles, and the like, reflects those emitted sound waves back to the ultrasound detector in a varying pattern. Controller 150 detects such reflected acoustic waves and causes apparatus 100 to provide a visual and/or audible alert.

In certain embodiments, sensor 160 and/or sensor 170 each comprise a photoelectric cell that can detect variations in light intensity. For example, pathway 215 comprises an ambient light intensity. As a person, animal, or vehicle, moves in pathway 215, that movement will cause a variation in the intensity of the ambient light intensity detected by sensor 160. Controller 150 detects such a variation of light intensity and causes apparatus 100 to provide a visual and/or audible alert. In certain embodiments, processor 422 recognizes regularly-occurring variation in the reflected acoustic sound waves, and/or in light intensity, i.e. a “flickering bulb” for example, and ignores such a varying light intensity.

In other embodiments, sensor 160 and/or sensor 170 comprises a pressure transducer disposed in the floor portion of pathway 215 and 225, respectively. Movement in either pathway activates that pressure transducer and causes processor 150 to activate one or more light emitting devices 180 and/or one or more sound emitting devices 190.

In certain embodiments, sensor 160 and/or sensor 170 comprises an infrared sensor comprising a crystalline material that generates a surface electric charge when exposed to heat in the form of infrared radiation. If the quantum of infrared radiation striking the crystal changes, the amount of charge also changes, and that change can then be measured with a sensitive FET device built into the sensor. In certain embodiments, Applicants' sensor comprises a filter window to limit incoming radiation to the 8 to 14 μm range.

In certain embodiments, each of Applicants' sensors comprises two sensing elements connected in a voltage bucking configuration. This arrangement cancels signals caused by vibration, temperature changes and sunlight. In addition, movement in a pathway will activate a first element and then subsequently activate the second element whereas other sources will affect both elements simultaneously and be cancelled. When using visible light, sensors will face out the sides of the unit, into the monitored area.

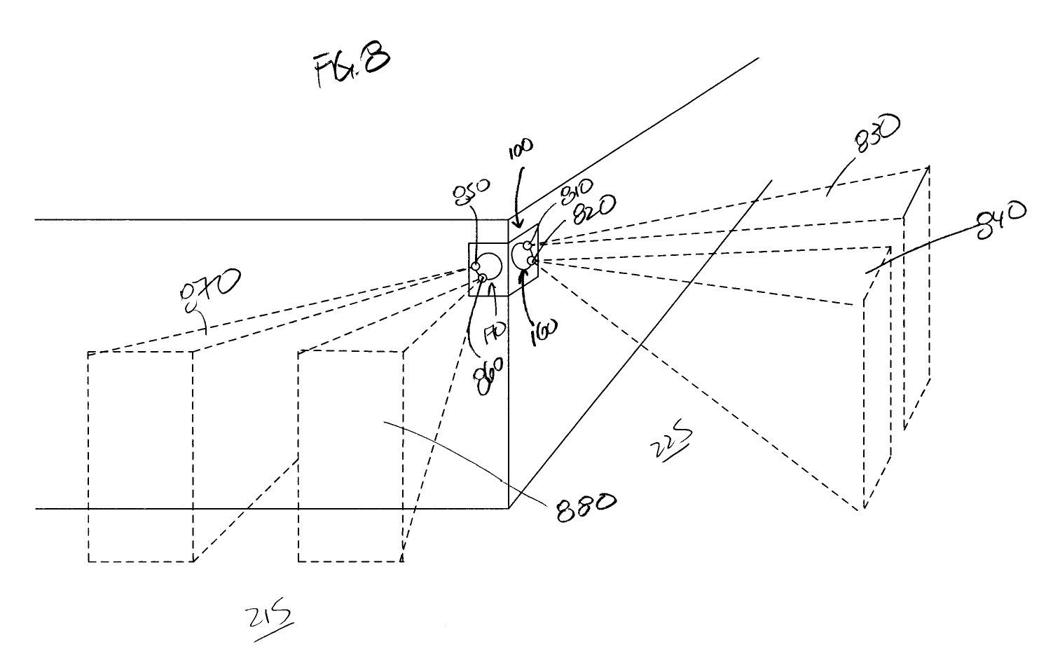

For example and referring to FIG. 8, sensor 160 comprises sensor element 810 which can detect movement through zone 830. Sensor 160 further comprises sensor element 820 which can detect movement through zone 840. Similarly, sensor 170 comprises sensor element 850 which can detect movement through zone 870. Sensor 170 further comprises sensor element 860 which can detect movement through zone 880.

In certain embodiments, the two sensing elements each comprise an infrared device. In these embodiments, a moving person, animal, vehicle, causes a variation in the ambient temperature detected by a first pyroelectric device and then causes a variation in the ambient temperature detected by a second pyroelectric device.

In certain embodiments, the two sensing elements each comprise a photoelectric cell. In these embodiments, a moving person, animal, vehicle, causes a variation in the ambient light intensity detected by a first photoelectric cell and then causes a variation in the ambient light intensity detected by a second photoelectric cell.

In certain embodiments, the two sensing elements each comprise an ultrasound detector. In these embodiments, a moving person, animal, vehicle, reflects the emitted acoustic waves to a first ultrasound detector and then reflects the emitted acoustic waves to a second ultrasound detector.

In certain embodiments of Applicants' method, a moving person, animal, or vehicle, must pass across the sensor in a horizontal direction so that the first element and the second element are sequentially exposed to the motion source in order to cause Applicants' pedestrian alert device to display a visual warning or emit an audible warning. For example when using infrared sensors, if a first infrared sensor detects a temperature variation, and then a second infrared sensor detects a temperature variation, Applicants' apparatus and method display a visual warning and/or emits an audible warning. Such an infrared sensor is sold in commerce under the designation PIR325 Pyroelectric sensor by Glolab Corp., 307 Pine Ridge Drive, Wappingers Falls, N.Y. 12590.

In the illustrated embodiment of FIG. 1B, power source 140 and controller 150 are disposed in housing 110. In certain embodiments of Applicants' apparatus 100, one or more first light emitting devices 180 are disposed on the distal end and/or side of housing 120. In certain embodiments of Applicants' apparatus 100, one or more first sound emitting devices 190 are disposed on the distal end of housing 120. In certain embodiments of Applicants' apparatus 100, one or more second light emitting devices 180 are disposed on the distal end and/or side of housing 130. In certain embodiments of Applicants' apparatus 100, one or more second sound emitting devices 190 are disposed on the distal end of housing 130.

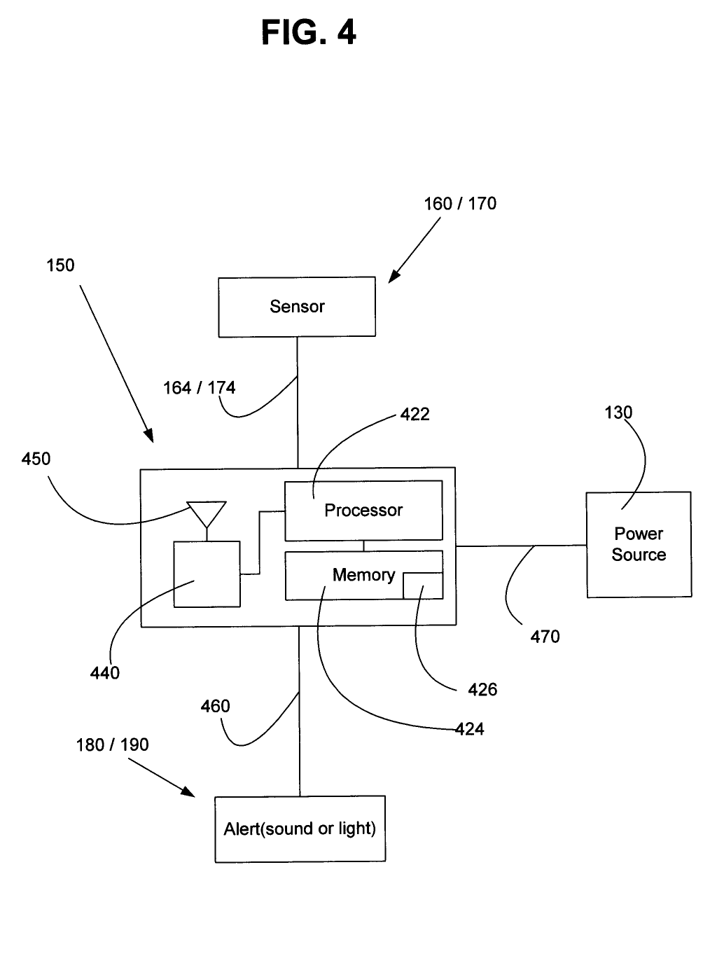

Referring now to FIG. 4, controller 150 comprises processor 422. In certain embodiments, processor 422 comprises one or more logic gates. In certain embodiments, controller 150 further comprises memory 424. In certain embodiments, memory 424 comprises non-volatile memory, such as for example battery backed-up RAM, a hard disk drive, electronic memory, and the like. By “electronic memory,” Applicants mean a device such as a PROM, EPROM, EEPROM, Flash PROM, compactflash, smartmedia, and the like. In certain embodiments, controller 150 further comprises instructions/microcode 426 written to memory 424. In certain embodiments, processor 422 utilizes instructions/microcode 426 to operate Applicants' apparatus 100. In certain embodiments, processor 422, memory 424, and instructions/microcode 426 comprise an integrated device. In certain embodiments, that integrated device comprises an application specific integrated circuit (“ASIC”).

Processor 150 is interconnected with each light emitting device 180, and each sound emitting device 190, disposed in Applicants' apparatus via a communication link 460. Processor 150 is interconnected with power source 130 via power conduit 470.

In certain embodiments, controller 150 further comprises transmitting device 440 and antenna 450. Transmitting device 440 is interconnected with processor 422 and antenna 450 is interconnected with transmitting device 440. Transmitting device provides a wireless signal of limited power, such that the wireless signal can be received within only a limited reception distance from controller 150.

In certain embodiments, transmitter 440 provides a wireless alert signal comprising wavelength in the infrared spectrum, i.e. a wavelength between 0.7 to about 1.5 μm. In certain embodiments, transmitter 440 provides a wireless alert signal comprising ultrasonic sound waves comprises one or more frequencies between about 40 kHz and about 250 kHz.

In certain embodiments, transmitter 440 provides Bluetooth-compliant emissions at about 2.4 GHz. In other embodiments, transmitter 440 provides wireless signals that are IEEE Standard 802.11 compliant. Embodiments wherein transmitter 440 is compliant with the 802.11b and 802.11g standards provide signals transmitted at about 2.4 GHz. Embodiments wherein transmitter 440 is compliant with the 802.11a standard provides signals at about 5 GHz.

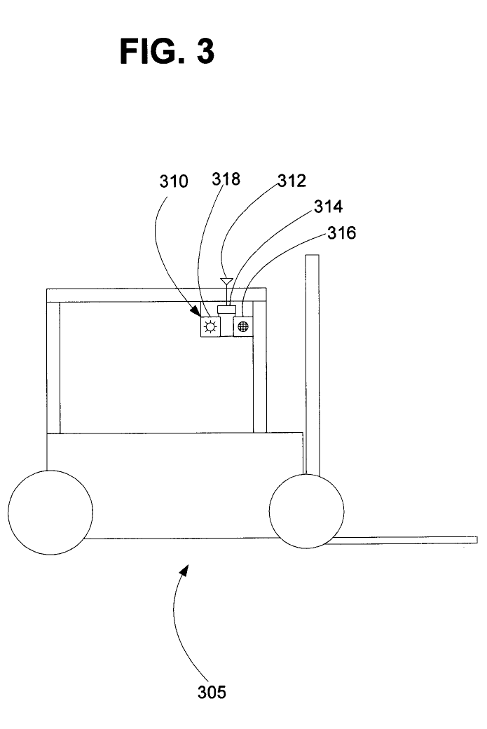

Referring now to FIG. 3, vehicle 305 comprises alert apparatus 310 comprising antenna 312, receiver device 314, one or more sound emitting devices 316, and/or one or more light emitting devices 318. In other embodiments, an alert can trigger a controlled shut down of the device, cause a reduction in speed, and the like. In the illustrated embodiment of FIG. 3, vehicle 305 comprises a fork lift apparatus. In other embodiments of Applicants' apparatus and method, vehicle 305 may comprise, for example and without limitation, a wheel barrow, a bicycle, a furniture dolly, a pallet jack, a robot, and the like.

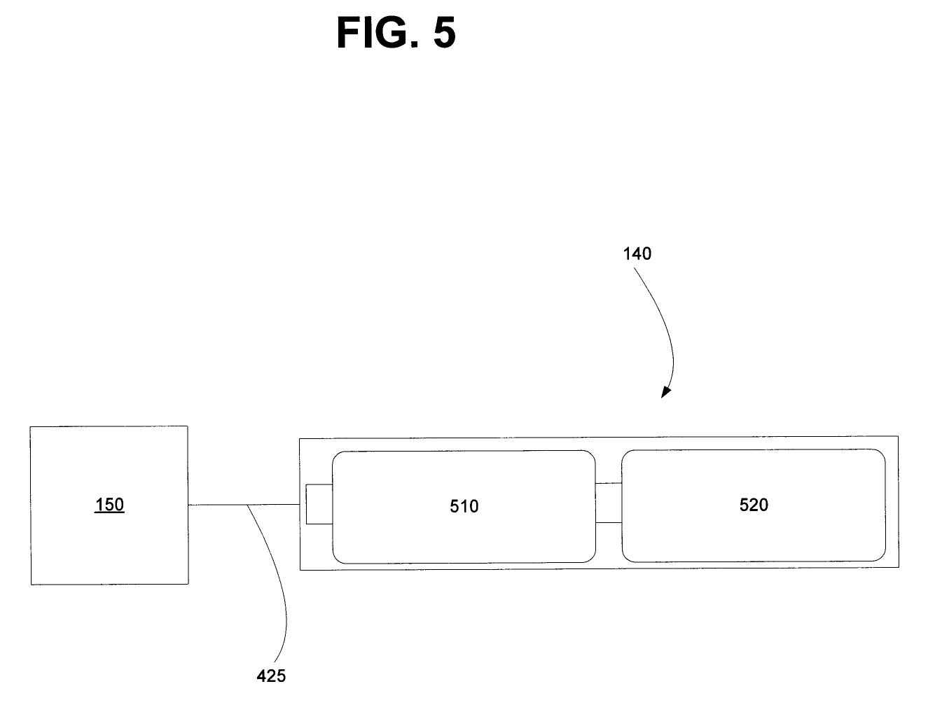

Referring now to FIG. 5, in certain embodiments, power source 140 comprises one or more batteries. In the illustrated embodiment of FIG. 5, power source 140 comprises battery 510 and battery 520. In certain embodiments, the one or more batteries comprise rechargeable batteries. These may be recharged by photoelectric cells, utility power, or other energy transferring devices.

In certain embodiments, apparatus 100 is powered using utility power, such as for example 110 volt 60 hertz power, 220 volt 50 hertz power, and the like. In these embodiments, power source 140 comprises a voltage transformer, or similar device, to convert the input utility power to an output power comprising about 3 to 12 volts.

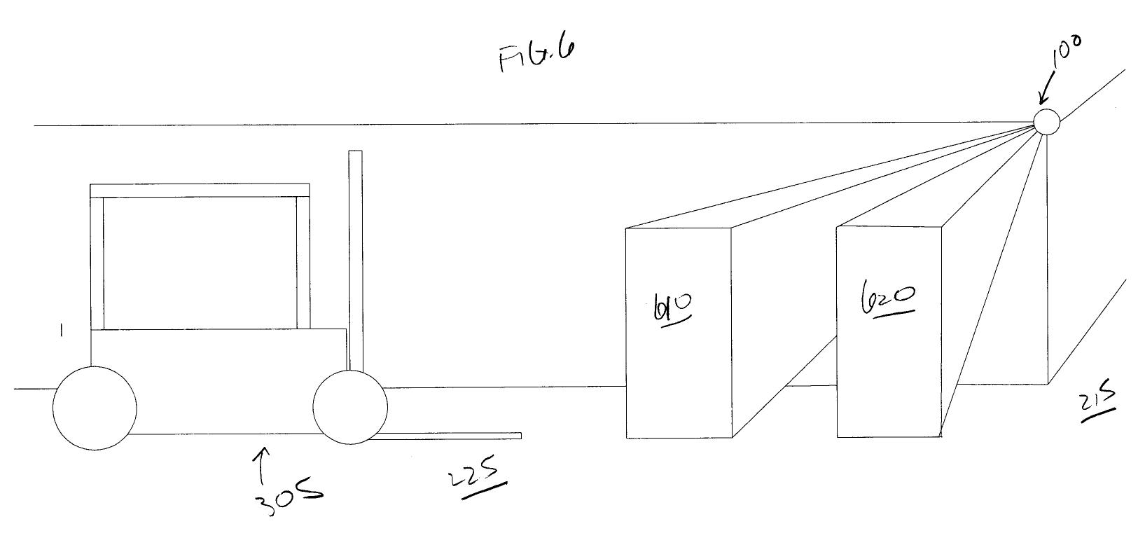

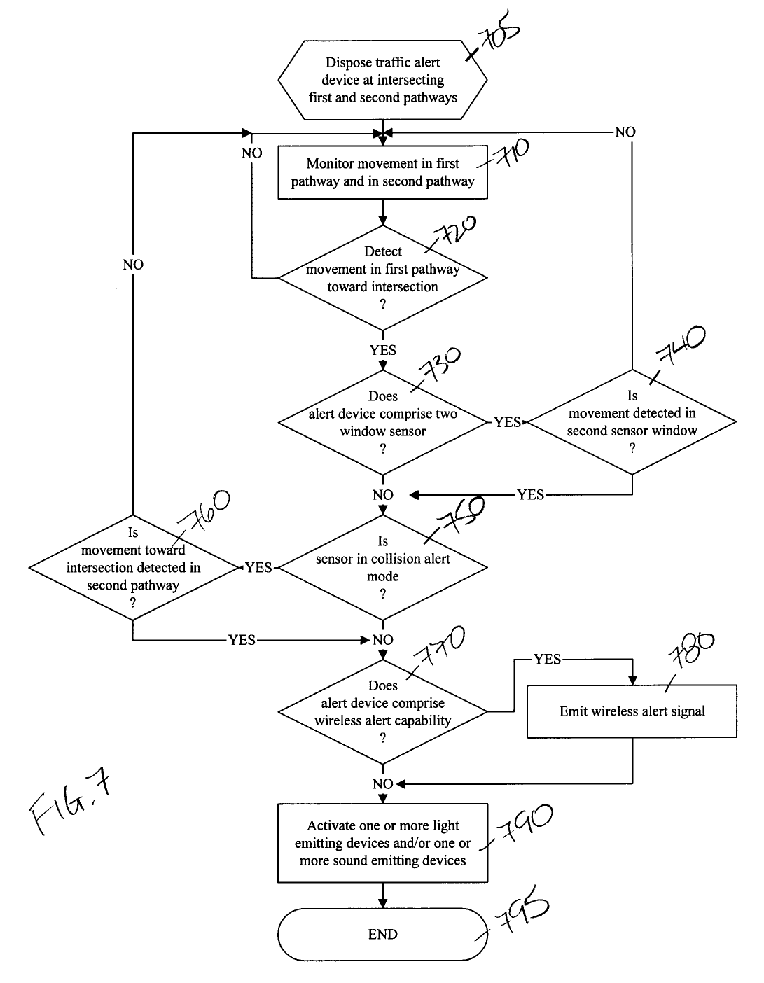

FIG. 7 summarizes the steps of Applicants' method using Applicants' alert apparatus 100 to prevent collisions at intersection pathways. Referring now to FIG. 7, in step 705 Applicants' method disposes a pedestrian alert device, such as Applicants' apparatus 100, at the intersection of a first pathway, such as for example hallway 215 (FIGS. 2, 6) and hallway 225 (FIGS. 2, 6).

In step 710, Applicants' pedestrian alert device monitors movement in the first pathway and in the second pathway. In step 720, Applicants' method determines if movement is detected in either the first pathway or in the second pathway. If Applicants' method determines in step 720 that no movement toward the intersection is detected in either the first pathway or in the second pathway, then the method transitions from step 720 to step 710 and continues as described herein.

Alternatively, if Applicants' method determines in step 720 that movement is detected in the first pathway and/or in the second pathway, then the method transitions from step 720 to step 730 wherein the method determines if the pedestrian alert device of step 705 comprises dual sensor elements. For example and in the illustrated embodiment of FIG. 6, the sensor, such as sensor 160 (FIGS. 1A, 1B) and/or sensor 170 (FIGS. 1A, 1B), disposed in alert apparatus 100 and monitoring pedestrian along pathway 225 comprises dual sensor elements such that the sensor can detect movement through zone 710 and can separately detect movement through zone 720.

For example and referring to FIG. 8, sensor 160 comprises sensor element 810 which can detect movement through zone 830. Sensor 160 further comprises sensor element 820 which can detect movement through zone 840. Similarly, sensor 170 comprises sensor element 850 which can detect movement through zone 870. Sensor 170 further comprises sensor element 860 which can detect movement through zone 880.

If Applicants' method determines in step 730 that the alert device of step 705 does not comprise dual sensor elements, then the method transitions from step 730 to step 750. Alternatively, if Applicants' method determines in step 730 that the alert device of step 705 does comprise dual sensor elements, then the method transitions from step 730 to step 740 wherein the method determines if movement has been detected in both of the sensor zones, such as zones 610 (FIG. 6) and 620 (FIG. 6), or zones 830 (FIG. 8) and 840 (FIG. 8), or zones 870 (FIG. 8) and 880 (FIG. 8). If Applicants' method determines in step 740 that movement has not been detected in both sensor zones, then the method transitions from step 740 to step 710 and continues as described herein. Alternatively, if Applicants' method determines in step 740 that movement has been detected in both sensor zones, then the method transitions from step 740 to step 750.

In certain embodiments, step 740 further comprises establishing a threshold time interval, wherein if movement is first detected in a first sensor element/first sensor window, the method then determines if movement is detected in the second sensor element/second sensor window within the threshold time interval. If the method determines that movement is detected in the second sensor element/second sensor window within the threshold time interval, then the method transitions from step 740 to step 750. In these embodiments, if Applicants' method determines in step 740 that movement is first detected in a first sensor element/first sensor window, but movement is not detected in the second sensor element/second sensor window within the threshold time interval, then the method transitions from step 740 to step 710 and continues as described herein.

In step 750, the method determines if the pedestrian alert device of step 705 is operating in a collision alert mode. By collision alert mode, Applicants mean that a visual and/or audible alert is only provided if the pedestrian alert device of step 705 detects movement in all monitored pathways.

If Applicants' method determines in step 750 that the pedestrian alert device of step 705 is not operating in a collision alert mode, then the method transitions from step 750 to step 770. If Applicants' method determines in step 750 that the pedestrian alert device of step 705 is operating in a collision alert mode, then the method transitions from step 750 to step 760 wherein the method determines if movement is detected in the second pathway. For example and referring to FIG. 2, in step 760 Applicants' method determines if movement is detected along direction arrow 1 in pathway 225 and also detected along direction arrow 2 in pathway 215.

If Applicants' method determines in step 760 that movement is not detected in both intersecting pathways, then the method transitions from step 760 to step 710 and continues as described herein. Alternatively, if Applicants' method determines in step 760 that movement is detected in both intersecting pathways, then the method transitions from step 760 to step 770 wherein the method determines if the pedestrian alert device of step 705 comprises wireless alert capability, such as comprising a transmitter 440 (FIG. 4) and optionally an antenna 450 (FIG. 4).

If Applicants' method determines in step 770 that the pedestrian alert device of step 705 does not comprise wireless alert capability, then the method transitions from step 770 to step 790. Alternatively, if the pedestrian alert device of step 705 does comprise wireless alert capability, then the method transitions from step 770 to step 780 wherein the method causes the pedestrian alert device to emit a wireless alert signal. Referring to FIGS. 3 and 7, if Applicants' pedestrian alert apparatus 100 emits a wireless alert signal in step 780, and if vehicle 305 is located with the reception distance of apparatus 100, then receiver device 314 receives the broadcast alert signal and one or more sound emitting devices 316 emit sound, and/or one or more light emitting devices 318 emit light, thereby alerting the operator of vehicle of 305 to pedestrian in an intersecting pathway.

Applicants' method transitions from step 780 to step 790 wherein the method causes one or more light emitting devices, such as for example one or more light emitting devices 180 (FIGS. 1A, 1B) to emit light, and/or causes one or more sound emitting devices, such as for example one or more sound emitting devices 190 (FIGS. 1A, 1B) to emit sound.

In certain embodiments, individual steps recited in FIG. 7 may be combined, eliminated, or reordered.

In certain embodiments, Applicants' invention includes instructions residing in microcode, such as for example microcode 426 (FIG. 4), where those instructions are executed by a processor, such as processor 422 (FIG. 4), to perform one or more of steps 710, 720, 730, 740, 750, 760, 770, 780, and/or 790, recited in FIG. 7.

In other embodiments, Applicants' invention includes instructions residing in any other computer program product, where those instructions are executed by a computer external to, or internal to, apparatus 100, to perform one or more of steps 710, 720, 730, 740, 750, 760, 770, 780, and/or 790, recited in FIG. 7. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

In other embodiments, pedestrian alert sensors disposed in a plurality of assemblies 100 disposed throughout a facility are interconnected, wirelessly or via hard communication links, to a central computing device, such as for example a mainframe computer. In certain embodiments, each remote sensor comprises a unique identifier which is provided to the central computing device when a pedestrian conflict is detected. In certain embodiments, central computing devices can activate certain devices to flash, or otherwise indicate, marking the escape route in an emergency such as a smoke filled environment, fire, or other disaster.

In certain embodiments, Applicants' central computing device monitors and controls pedestrians throughout the entire facility. In certain embodiments, Applicants' remote computing device is capable of activating a plurality of light emitting and/or sound emitting devices disposed in a plurality of local pedestrian monitoring devices 100, such as in an emergency situation.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to monitor movement in intersecting pathways, comprising the steps of:
supplying a pedestrian alert device comprising a light emitting device;
disposing said pedestrian alert device at the intersection of a first and a second pathway, wherein said pedestrian alert device is capable of detecting movement in said first pathway and in said second pathway;
detecting movement in said first pathway;
activating said light emitting device.

2. The method of claim 1, wherein:
said supplying a pedestrian alert device step further comprises supplying a pedestrian alert device comprising an audio device;
said activating step further comprises causing said audio device to emit an audible sound.

3. The method of claim 1, wherein said supplying and disposing steps comprise:
supplying a pedestrian alert device comprising a first sensor and a second sensor;
disposing said pedestrian alert device such that said first sensor faces said first pathway and said second sensor faces said second pathway.

4. The method of claim 3, wherein said supplying a pedestrian alert device step further comprises supplying a pedestrian alert device comprising a first sensor comprising a first ultrasound transducer in combination with one or more first ultrasound detectors and a second sensor comprising a second ultrasound transducer in combination with one or more second ultrasound detectors.

5. The method of claim 3, wherein said supplying a pedestrian alert device step further comprises supplying a pedestrian alert device comprising a first sensor comprising one or more first photoelectric cells and a second sensor comprising one or more second photoelectric cells.

6. The method of claim 3, wherein said supplying a pedestrian alert device step further comprises supplying a pedestrian alert device comprising a first sensor comprising one or more first infrared detectors and a second sensor comprising one or more second infrared detectors.

7. The method of claim 3, wherein:
said supplying a pedestrian alert device step further comprises supplying a pedestrian alert device wherein said first sensor comprises a first sensing element and a second sensing element said detecting movement step and said activating step comprise:
detecting movement by said first sensing element at a first time;
determining if movement is detected by said second sensing element at a second time, wherein said second time is later than said first time;
operative if movement is detected by said second sensing element at a second time, activating said light emitting device.

8. The method of claim 7, further comprising the steps of:
establishing a threshold time interval;
wherein said determining if movement is detected by said second sensing element at a second time step comprises determining if movement is detected by said second sensing element within said threshold time interval.

9. The method of claim 7, wherein;
said first pathway comprises an ambient temperature;
said first sensing element comprises a first infrared sensor;
said second sensing element comprises a second infrared sensor;
wherein said detecting movement by said first sensing element comprises detecting a temperature variation by said first pyroelectric sensor; and
wherein said detecting movement by said second sensing element comprises detecting a temperature variation by said second pyroelectric sensor.

10. The method of claim 7, wherein:
said first pathway comprises an ambient light intensity;
said first sensing element comprises a first photoelectric sensor;
said second sensing element comprises a second photoelectric sensor;
wherein said detecting movement by said first sensing element comprises detecting a variation in said ambient light intensity by said first photoelectric sensor; and
wherein said detecting movement by said second sensing element comprises detecting a variation in said ambient light intensity by said second photoelectric sensor.

11. The method of claim 1, wherein said first pathway comprises a first hallway in a building, and wherein said second hallway comprises a second hallway in said building.

12. The method of claim 1, wherein said detecting and activating steps comprise:
detecting movement in said first hallway
determining if movement is detected in said second hallway;
operative if movement is detected in both said first hallway and said second hallway, activating said light emitting device.

13. The method of claim 12, wherein;
said supplying a pedestrian alert device step comprises supplying a pedestrian alert device comprising a first light emitting device and a second light emitting device;
said disposing step comprises disposing said pedestrian alert device at the intersection of said first hallway and said second hallway such that said first light emitting device can be seen from said first hallway and such that said second light emitting device can be seen from said second hallway;
said activating step comprises causing said first light emitting device to project a visible light down said first hallway and causing said second light emitting device to project a visible light down said second hallway.

14. The method of claim 13, wherein:
said supplying a pedestrian alert device step audio emitting device;
said disposing step comprises disposing said pedestrian alert device at the intersection of said first hallway and said second hallway such that said first audio device faces said first hallway and such that said second audio device faces said second hallway;
said activating step comprises causing said first audio to project an audible sound down said first hallway and causing said second audio device to project an audible sound down said second hallway.

15. The method of claim 1, further comprising the step of disposing said pedestrian alert device above a door comprising a first side and a second side, wherein said first side of said door comprises said first pathway, and said second side of said door comprises said second pathway.

16. A pedestrian alert device, comprising:
a housing comprising a first surface facing a first direction and a second surface facing a second direction, wherein said first direction differs from said second direction;
a controller disposed within said housing;
a first sensor disposed on said first surface and interconnected with said controller;
a second sensor disposed on said second surface and interconnected with said controller;
at least one light emitting device disposed on said housing and interconnected with said controller.

17. The pedestrian alert device of claim 16, wherein:
said first sensor comprises a first ultrasound transducer in combination with one or more first ultrasound detectors; and
said second sensor comprises a second ultrasound transducer in combination with one or more second ultrasound detectors.

18. The pedestrian alert device of claim 16, wherein:
said first sensor comprises one or more first photoelectric cells;
said second sensor comprises one or more second photoelectric cells.

19. The pedestrian alert device of claim 16, wherein:
said first sensor comprises one or more first pyroelectric detectors; and
said second sensor comprises one or more second pyroelectric detectors.

20. The pedestrian alert device of claim 16, wherein:
said first sensor comprises a first sensing element and a second sensing element;
said second sensor comprises a first sensing element and a second sensing element.

21. The pedestrian alert device of claim 16, further comprising:
a first audio device disposed on said first surface and interconnected with said controller;
a second audio device disposed on said first surface and interconnected with said controller.
